(19) United States
(12) Patent Application Publication
(10) Pub. No.: US 2007/0047122 A1
(43) Pub. Date: Mar. 1, 2007

(54) TAPE HEAD HAVING WRITE DEVICES AND NARROWER READ DEVICES

(75) Inventors: W. Stanley Czarnecki, Palo Alto, CA (US); Icko E. T. Iben, Santa Clara, CA (US)

Correspondence Address: ZILKA-KOTAB, PC, P.O. BOX 721120, SAN JOSE, CA, 95172-1120, US

(73) Assignee: INTERNATIONAL BUSINESS MACHINES CORPORATION

(21) Appl. No.: 11/216,614

(22) Filed: Aug. 30, 2005

(51) Int. Cl. G11B 5/02

(52) U.S. Cl. 360/55

(57) ABSTRACT

A magnetic head, such as a tape head, according to one embodiment includes an array of data writers for writing to multiple data tracks on a magnetic medium, a width of the array being defined between the data writers positioned farthest apart. An erase writer having a width at least about as wide as the width of the array is present for erasing at least part of the magnetic medium prior to the writing by the data writers. A plurality of readers may also be present. Preferably, the data writers and erase writer are formed on the same substrate.

### FIELD OF THE INVENTION

The present invention relates to magnetic head structures, and more particularly, this invention relates to a magnetic head structure having a wide writer that pre-erases at least a portion of a magnetic medium prior to writing thereto.

### BACKGROUND OF THE INVENTION

Business, science and entertainment applications depend upon computers to process and record data, often with large volumes of the data being stored or transferred to nonvolatile storage media, such as magnetic discs, magnetic tape cartridges, optical disk cartridges, floppy diskettes, or floptical diskettes. Typically, magnetic tape is the most economical and convenient means of storing or archiving the data. Storage technology is continually pushed to increase storage capacity and storage reliability. Improvement in data storage densities in magnetic storage media, for example, has resulted from improved medium materials, improved error correction techniques and decreased areal bit sizes. The data capacity of half-inch magnetic tape, for example, is now measured in hundreds of gigabytes on 704 data tracks.

The improvement in magnetic medium data storage capacity arises in large part from improvements in the magnetic head assembly used for reading and writing data on the magnetic storage medium. A major improvement in transducer technology arrived with the magnetoresistive (MR) sensor originally developed by the IBM® Corporation. The MR sensor transduces magnetic field changes in a MR stripe to resistance changes, which are processed to provide digital signals. Data storage density can be increased because a MR sensor offers signal levels higher than those available from conventional inductive read heads for a given bit area. Moreover, the MR sensor output signal depends only on the instantaneous magnetic field intensity in the storage medium and is independent of the magnetic field time-rate-of-change arising from relative sensor/medium velocity.

The quantity of data stored on a magnetic tape may be increased by increasing the number of data tracks on the tape, which also decreases the distance between adjacent tracks and forces adjacent read/write heads closer together. More tracks are made possible by reducing feature sizes of the read and write elements, such as by using thin-film fabrication techniques and MR sensors. In operation the magnetic storage medium, such as tape or a magnetic disk surface, is passed nearby the magnetic read/write (R/W) head assembly for reading data therefrom and writing data thereto. In modern magnetic tape recorders adapted for computer data storage, read-while-write capability with MR sensors is an essential feature for providing fully recoverable magnetically stored data. The interleaved R/W magnetic tape head with MR sensors allows increased track density on the tape medium while providing bi-directional read-while-write operation of the tape medium to give immediate read back verification of data just written onto the tape medium. A read-while-write head assembly typically includes, for each of one or more data tracks, a write element in-line with a read element, herein denominated a R/W pair, wherein the gap of the read element is closely-disposed to and aligned with the gap of the write element, with the read element positioned downstream of the write element in the direction of medium motion. By continually reading just-recorded data, the quality of the recorded data is immediately verified while the original data is still available in temporary storage in the recording system. The recovered data is compared to the original data to afford opportunity for action, such as re-recording, to correct errors. In the interleaved head, the R/W track-pairs are interleaved to form two-rows of alternating read and write elements. Alternate columns (track-pairs) are thereby disposed to read-after-write in alternate directions of tape medium motion. Tape heads suitable for reading and writing on high-density tapes also require precise alignment of the track-pair elements in the head assembly.

FIG. 1 illustrates a head 100 which has several R/W pairs 102 matched in a “piggyback” configuration, and which can also function as a read-while-write head. Servo readers 104 are positioned on the outside of the array of RIW pairs 102. The servo readers 104 follow servo tracks for the particular data wrap at a given servo position of the tape being read or written to, their signal being used to keep the head aligned with the band. The tape may have a single or many servo tracks, and each band may have one or more servo tracks.

When the head is constructed, layers are formed on a substrate 110 in generally the following order for the R/W pairs 102: an electrically insulative layer 112, a first shield (S1) 114 formed directly on the insulative layer 112, a sensor 116 also known as a read element, and a second shield (S2) 118, and first and second writer pole tips (P1, P2) 120,122. Note also that the second shield 118 and first writer pole tip 120 may be merged into a single structure.

In order to write high density data on magnetic storage tape media, the written tracks need to be ever closer to one another. Current technology uses wide writers and narrow readers which are separated from one another on the head by much larger distances than the track-to-track spacing. Because of the spacing, any track misregistration can result in reading the older data that exists between the data tracks, which in turn results in errors.

An alternative is to use adjacent track writing where the writers are essentially side-by-side and write adjacent tracks. Readers then would also be adjacent to one another. One could then allow the readers to overlap the written tracks and use some form of deconvolution scheme to extract the written information. A problem is that when over-writing previously written tape, any separation between adjacent writers will result in a fraction of old data (sometimes called remnant data) being read by the overlapping readers resulting in added noise, which in turn results in errors.

There is accordingly a clearly-felt need in the art for a head assembly capable of erasing old data prior to writing data tracks. These unresolved problems and deficiencies are clearly felt in the art and are solved by this invention in the manner described below.

### SUMMARY OF THE INVENTION

A magnetic head, such as a tape head, according to one embodiment includes an array of data writers for writing to multiple data tracks on a magnetic medium (such as a magnetic tape, hard disk, etc.), a width of the array being defined between the data writers positioned farthest apart. An erase writer having a width at least about as wide as the width of the array is present for erasing at least part of the magnetic medium prior to the writing by the data writers. A plurality of readers may also be present. Preferably, the data writers and erase writer are formed on the same substrate, and can form part of a read-while-write head, interleaved head, write-only head, etc.

In one embodiment, the erase writer has a width greater than the width defined by the data writers positioned farthest apart. In another embodiment, the width of the erase writer is at least as wide as the array of data writers, but does not erase a servo area of the data band (which preferably includes several data tracks). In yet another embodiment, the erase writer spans an entire width of the magnetic medium as measured perpendicular to a direction of travel of the magnetic medium relative to the magnetic head.

In an embodiment, one or more of the readers can overlap multiple data tracks and use a deconvolution scheme to extract data.

In further embodiments, the erase writer may include two or more write elements.

A tape drive system includes a head as recited above, a drive mechanism for passing a magnetic recording tape over the head, and a controller in communication with the head.

Methods for forming such heads are also presented.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a representative view of a typical multitrack tape head having a multitude of readers and writers.

FIG. 2 is a representative tape bearing surface view of a multitrack tape head having a plurality of data writers and an erase writer according to one embodiment of the present invention.

FIG. 3 is a representative tape bearing surface view of a multitrack tape head according to another embodiment, where the readers overlap multiple data tracks.

FIG. 4 is a representative tape bearing surface view of a multitrack tape head according to a further embodiment, where the erase writer includes two write elements.

FIGS. 5A-B are representative tape bearing surface views of a multitrack tape head according to another embodiment, where the erase writer includes outer write elements flanking an inner element.

FIG. 6 is a representative tape bearing surface view of a multitrack tape head according to an embodiment not having an erase writer.

FIG. 7 is a schematic diagram of the tape drive system.

### BEST MODE FOR CARRYING OUT THE INVENTION

The following description is the best embodiment presently contemplated for carrying out the present invention. This description is made for the purpose of illustrating the general principles of the present invention and is not meant to limit the inventive concepts claimed herein. Further, particular features described herein can be used in combination with other described features in each of the various possible combinations and permutations.

In the drawings, like and equivalent elements are numbered the same throughout the various figures.

As described herein, the preferred embodiments of magnetic heads generally each include a plurality of data writers, and an erase writer that pre-erases the magnetic medium just prior to the data writers writing new data. This results in a nearly pristine “erased” data area being presented to the data writers so only the desired data will be in the written area. With the erase writer operating simultaneously to writing the data tracks and on the same head, the relevant portion of the tape can be clean prior to each writing pass. Also, where the erase writer is on the same head, an additional pass of a separate erase writer is avoided.

To aid the reader and to put the invention in context, the following description will refer to the invention in terms of a tape drive system. It should be understood that the teachings herein are applicable to all types of magnetic recording, including but not limited to analog and digital tape storage systems including those used for storing audio, video and data; hard disk drives; etc.

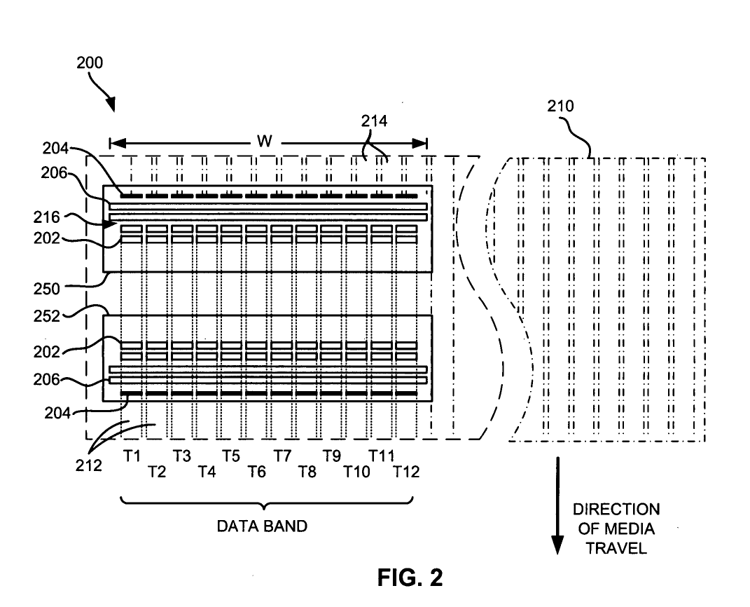

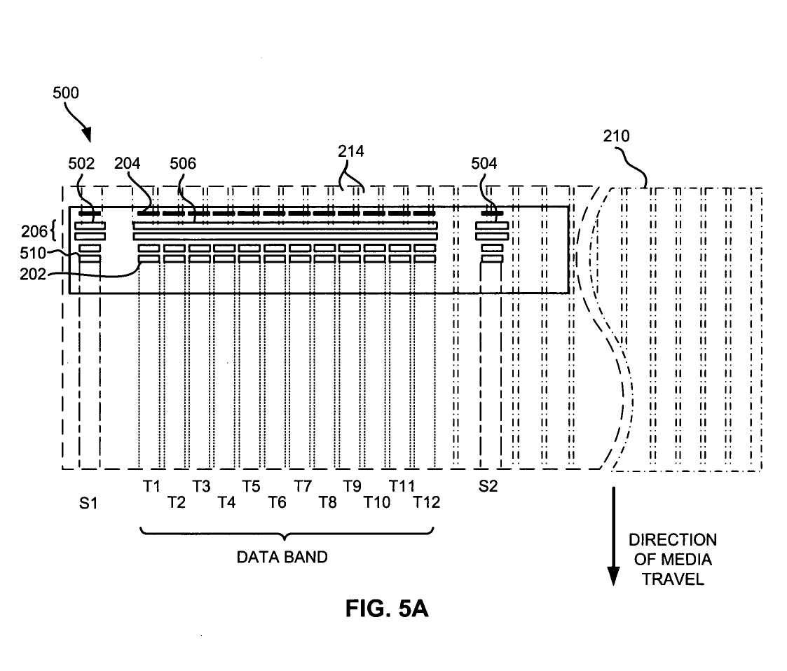

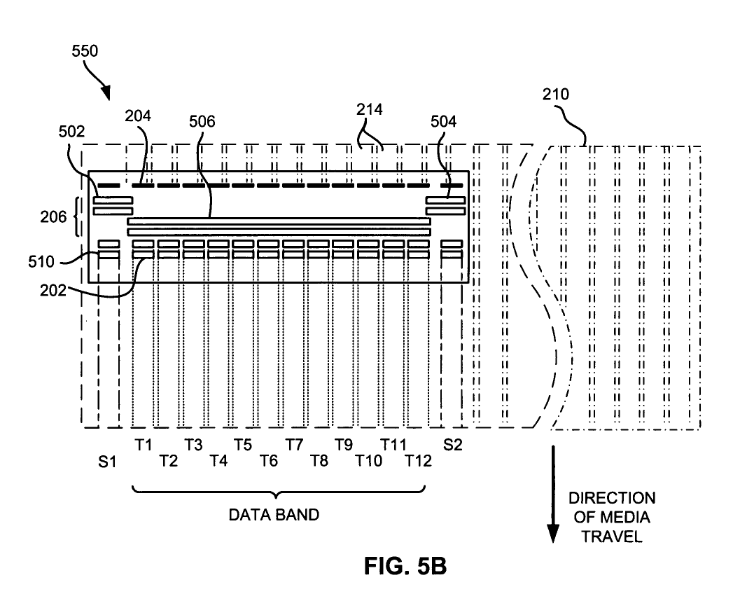

FIG. 2 illustrates a magnetic tape head 200 according to one embodiment of the present invention. As shown, the head includes two modules 250, 252, each module having an array of twelve data writers 202, an array of readers 204, and an erase writer 206 having a single write element. Also shown in shadow is a magnetic tape medium 210. Note also that servo readers (not shown) may be present on the head 200 (see FIG. 5).

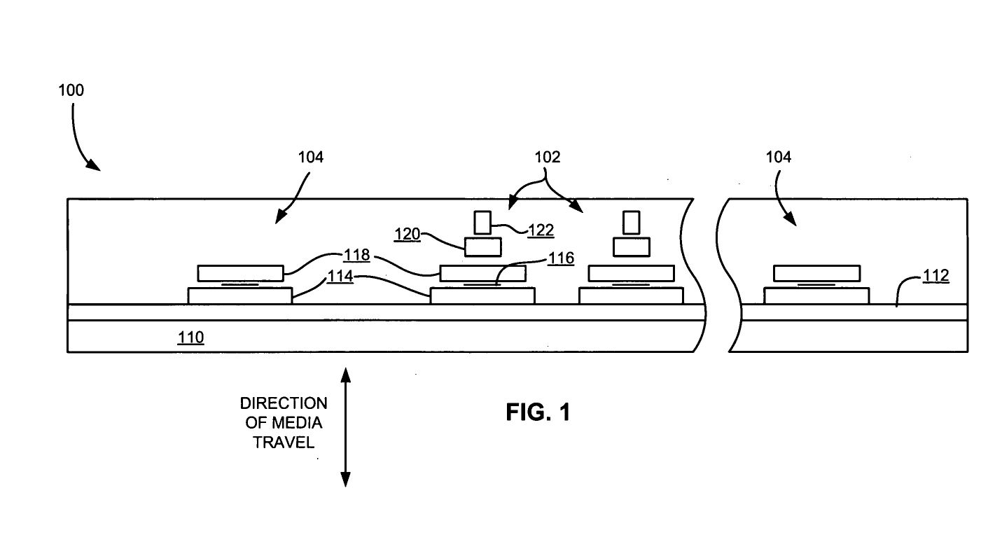

The head 200 is preferably a read-while-write head and can have a piggybacked configuration (as in FIG. 1), an interleaved configuration, etc. Alternatively, the head 200 may include one module with only the erase writer 206 and the data writers 202, with the readers 204 formed on a different module of the head, or on a different head altogether. In one embodiment, the head 200 can include the readers 204 and associated shields formed on a thin undercoat insulating layer sputtered on the substrate.

The readers 204 and data writers 202 can be of the type currently in use in the industry. The construction and operation of data writers 202 and readers 204 are well known in the art, and so only a general description thereof will be provided. In general, a magnetic flux is created by the data writers 202, which orients the direction of magnetization of magnetic grains in the medium 210 passing thereby, thus creating data tracks 212 (indicated as T1-T12). In a digital system, one orientation represents a data “one” and another orientation represents a data “zero.” The electrical resistances of the readers 204 to a sense current passing therethrough are affected by the different magnetic orientations. By sensing variations in this resistance, data from the medium 210 can be read.

The erase writer 206 may be formed on the same structure as the writers 202, or may be formed on the separate structure, and the two structures coupled together to form the head.

The erase writer 206 in this embodiment has a width W that spans the width of the data writer array and pre-erases the tape just prior to the data writers 202 writing new data. For instance, as shown in FIG. 2, assume existing data tracks 214 are present on the medium 210. During a data write operation, the erase writer 206 erases these previously-written data tracks 214 so that a nearly pristine “erased” area 216 is presented to the data writers 202 prior to writing the desired data tracks 212.

The erase writer 206 can have a configuration similar to the data writers 202, however with a wider width. For example, the poles and coil(s) of the erase writer 206 can be formed from the same or similar materials as the data writers 202, the write gap can be of a similar width, etc. The spacing between the erase writer 206 and the data writers 202 does not appear to be critical, as long as the erase field generated by the erase writer 206 does not interfere with data write operations.

The erase writer 206 may be operated with a constant current during the erase process, thereby functioning as a direct current (DC) erase writer 206. In FIG. 2, the tape medium 210 moves in the direction shown during the writing process. The erase writer 206 is maintained with a sufficient DC current to orient the tape magnetization uni-directionally for “DC erasure”. The data writers 202 then write data to the tape. Any data previously written to the medium 210 would no longer be present and thus would not be read by the readers 204 during a later readback operation.

As an example of the feasibility of the wide writer track, in existing drives for writing 100 GB tape cartridges used in LTO tape storage, data writers 202 which write 26 micron wide tracks are used. Older products use even wider tracks. For future products which might have 1 micron wide data tracks, a single 26 micron wide erase writer 206 provides the capability of erasing 26 tracks.

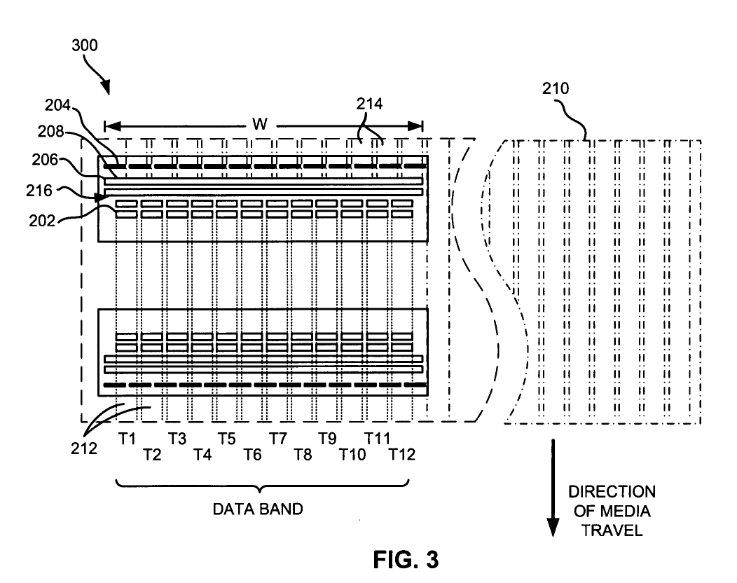

FIG. 3 illustrates a variation of the tape head shown in FIG. 2. On the head 300 shown in FIG. 3, the readers 204 (which may be on a different module than the writers 202) are offset from the writers 202 such that the readers 204 overlap the data tracks 212. Note that the number of readers 204 is greater than the number of data writers 202. Some readers 204 read multiple data tracks 212, while other readers 204 may read only a single track 212, a servo track, or even no data track if outside the data band. In such embodiments, a deconvolution scheme known in the art can be performed to extract the data from each signal. One skilled in the art will appreciate the importance of having no remnants of data in the spacing between the data tracks, as such remnants would interfere with the deconvolution scheme and ultimately recovery of the most recently written data.

Note also that deconvolution schemes can be used to account for track misregistration or other track/element misalignments in any of the embodiments described herein.

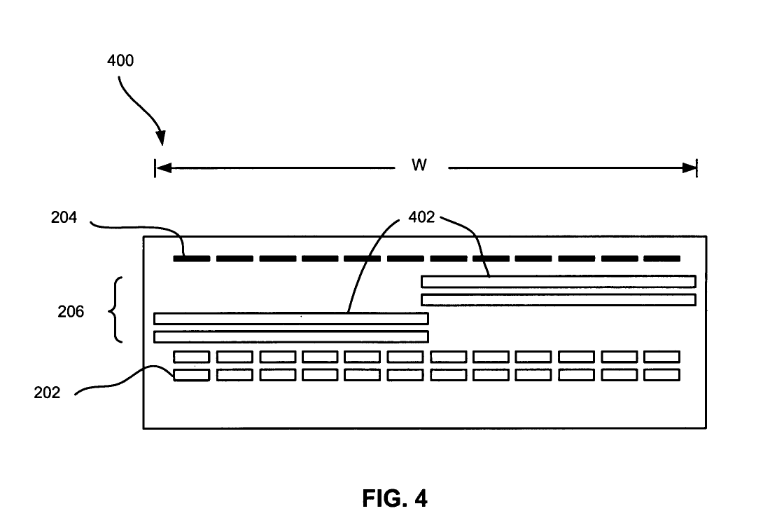

Another embodiment of the present invention includes an erase writer 206 with two or more write elements, e.g., poles and coil structure. FIG. 4 depicts a magnetic head 400 in which two write elements 402 of the erase writer are misaligned, each element 402 covering about half the width of the array of data writers 202. Preferably, the write elements 402 overlap somewhat as shown so that a complete erase is performed. Including multiple write elements in the erase writer 206 may be advantageous where the width of the erase writer 206 is so great as to result in uneven flux and thus inconsistent erasure.

In additional embodiments 500, 550 shown in FIGS. 5A-B, the erase writer 206 includes outer write elements 502, 504 flanking one or more inner elements 506. The outer write elements 502, 504 can operate at a reduced write voltage as compared to the write element(s) 506 sandwiched thereby so as to reduce the chance of interfering with adjacent data bands. In other words, by operating the outer writer elements 502, 504 at lower power, fringe fields are reduced, which in turn reduces the chance of erasing data or servo tracks from an adjacent data band. These embodiments are particularly useful for heads with servo writers 510 that write servo tracks S1, S2 during data writing. Because the servo data is less critical from a data retrieval standpoint, a partial erasure may be sufficient for most situations and is often preferable to no erasure.

FIG. 5A is preferred for embodiments where the servo writers 510 are positioned far from the data writers 202. FIG. 5B is preferred where the servo writers 510 are positioned near the data writers 202, e.g., within about a track width thereof. The overlap of the erase writer elements 502, 504, 506 in embodiment 550 (FIG. 5B) ensures no data remains anywhere in the data band defined by the servo tracks S1, S2. However, it may be desirable to create a hybrid of the two embodiments 500, 550, such that the erase writer elements overlap though the servo tracks are far from the data bands. Once the existing servo tracks are erased, the servo writers 510 can write new servo tracks S1, S2.

In a further embodiment, the erase writer has a width that fits between the servo tracks of a particular data band. One example would be the head 500 of FIG. 5A, where the erase writer only includes write element 506 and not the outer elements 502, 504. Accordingly, the term “data writers” may or may not encompass servo writers 510, as in the case where the head includes several data writers 202 and an outer servo writer(s) 510 for simultaneous servo/data writing. In such case, the width of the erase writer 506 can be reduced to be within a width defined by inner edges of the servo writers. In this way, the most sensitive area, i.e., the data area of the data band, can be erased prior to writing. The servo areas of the data band, which are less critical from a data retrieval accuracy standpoint, do not need to be erased and can merely be overwritten by the servo writers.

In another variation, the erase writer spans an entire width of the magnetic medium as measured perpendicular to a direction of travel of the magnetic medium relative to the magnetic head. This embodiment is particularly useful where the head writes only one data band to the medium.

In certain embodiments of the present invention, the data writers, readers, and erase writer are all formed on a single substrate. Implementing the erase writer in any type of magnetic head is no more difficult than building RIW piggybacked heads. When a head such as that shown in FIG. 1 is constructed, layers are formed on a substrate in generally the following order for the R/W pairs: an insulating layer typically of alumina, a first shield, a sensor also known as a read element, a second shield, and first and second writer poles. To create heads in accordance with the present invention such as, for example, those shown in FIGS. 2-5, after forming the first and second writer poles and overlying insulation, the poles of the erase writer and associated coil structure can be formed. Note that additional layers may be added and others removed per the desires of the designer.

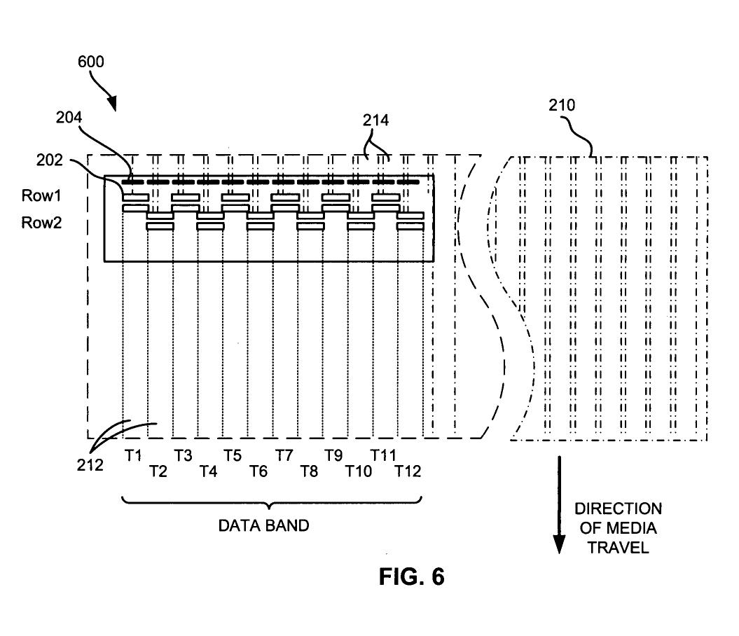

FIG. 6 depicts an alternative head 600 in accordance with the present invention that does not include an erase writer. The data writers 202 are stacked in alternate rows with the data writers 202 in the forward row with respect to tape motion (Row1) being slightly wider than the data writers 202 in the second row (Row2). Since data tracks written by writers in Row2 are written after those written by the writers of Row1, the data tracks from Row2 will slightly over-write the tracks from Row1. While extant tape drive systems use a similar “over-write” method called shingling to write adjacent tracks, since the overlapping tracks are written on very different passes of the tape over the head, track misregistration can be very large (several microns), making the current method of “shingling” obsolete for small adjacent track writing. The large track misregistration from multi-pass shingling is minimized by making the overlapping writers part of the single pass design.

Any of the embodiments described herein can be manufactured using conventional semiconductor processing

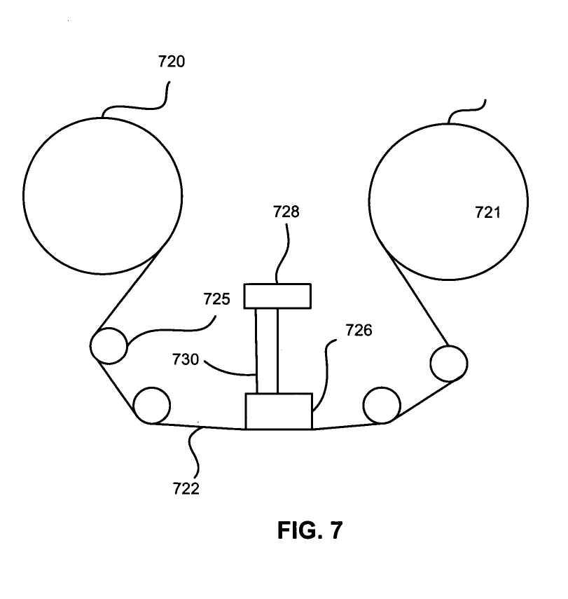

FIG. 7 illustrates a simplified tape drive which may be employed in the context of the present invention. While one specific implementation of a tape drive is shown in FIG. 7, it should be noted that the embodiments of the previous figures may be implemented in the context of any type of drive (i.e. hard drive, tape drive, etc.)

As shown, a tape supply cartridge 720 and a take-up reel 721 are provided to support a tape 722. These may form part of a removable cassette and are not necessarily part of the system. Guides 725 guide the tape 722 across a preferably bidirectional tape head 726, of the type disclosed herein. Such tape head 726 is in turn coupled to a controller assembly 728 via an MR connector cable 730. The controller 728, in turn, controls head functions such as servo following, write bursts, read functions, etc.

A tape drive, such as that illustrated in FIG. 7, includes drive motor(s) to drive the tape supply cartridge 720 and the take-up reel 721 to move the tape 722 linearly over the head 726. The tape drive also includes a read/write channel to transmit data to the head 726 to be recorded on the tape 722 and to receive data read by the head 726 from the tape 722. An interface is also provided for communication between the tape drive and a host (integral or external) to send and receive the data and for controlling the operation of the tape drive and communicating the status of the tape drive to the host, all as will be understood by those of skill in the art.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A magnetic head, comprising:
an array of data writers for writing to multiple data tracks on a magnetic medium, a width of the array being defined between the data writers positioned farthest apart; and
an erase writer having a width at least about as wide as the width of the array, the erase writer erasing at least a portion of the magnetic medium prior to the writing by the data writers.

2. The head as recited in claim 1, wherein the erase writer has a width greater than the width of the array.

3. The head as recited in claim 1, further comprising a plurality of readers for reading data from the data tracks.

4. The head as recited in claim 3, wherein at least some of the readers overlap multiple data tracks.

5. The head as recited in claim 1, wherein the data writers and erase writer are all formed on a single substrate.

6. The head as recited in claim 1, wherein the multiple data tracks form a band on the magnetic medium, wherein several bands are written on the magnetic medium.

7. The head as recited in claim 1, wherein the erase writer spans an entire width of the magnetic medium as measured perpendicular to a direction of travel of the magnetic medium relative to the magnetic head.

8. The head as recited in claim 1, wherein the erase writer includes at least two write elements.

9. The head as recited in claim 9, wherein the erase writer includes two write elements flanking a third write element of the erase writer.

10. The head as recited in claim 1, wherein the erase writer erases a servo track, and further comprising a servo writer for writing a servo track.

11. The head as recited in claim 1, wherein the erase writer is positioned on a first structure, the data writers being positioned on a second structure separate from the first, wherein the first and second structures are coupled together to form the head.

12. The head as recited in claim 1, wherein the magnetic medium is a magnetic tape.

13. A tape drive system, comprising:
a magnetic head as recited in claim 1;
a drive mechanism for passing a magnetic recording tape over the magnetic head; and
a controller electrically coupled to the magnetic head.

14. A magnetic tape head, comprising:
a substrate;
an array of data writers coupled to the substrate, the data writers being for writing to multiple data tracks on a magnetic tape, a width of the array being defined between the data writers positioned farthest apart in the array;
an array of readers coupled to the substrate, the readers being for reading multiple tracks on the magnetic tape; and
an erase writer coupled to the substrate, the erase writer having a width at least about as wide as the width of the array of data writers, the erase writer erasing at least a portion of the magnetic tape prior to the writing by the data writers.

15. The head as recited in claim 14, wherein at least some of the readers are offset from the writers in a direction perpendicular to a direction of tape travel thereover.

16. The head as recited in claim 14, wherein the writers overlap each other.

17. The head as recited in claim 14, wherein the multiple data tracks form a band on the magnetic tape, wherein several parallel bands are written on the magnetic tape.

18. The head as recited in claim 14, wherein the erase writer spans an entire width of the magnetic tape as measured perpendicular to a direction of travel of the magnetic tape relative to the magnetic head.

19. The head as recited in claim 14, wherein the erase writer includes at least two write elements.

20. A tape drive system, comprising:
a magnetic head as recited in claim 14;
a drive mechanism for passing a magnetic recording tape over the magnetic head; and
a controller electrically coupled to the magnetic head.
